(19) United States
(12) Patent Application Publication
(10) Pub. No.: US 2023/0225409 A1
(43) Pub. Date: Jul. 20, 2023

(54) ATOMIZING CORE AND ATOMIZER

(71) Applicant: LUXSHARE PRECISION INDUSTRY COMPANY LIMITED, Shenzhen (CN)

(72) Inventors: HuaBing LI, Shenzhen (CN); ZhongYuan LAI, Shenzhen (CN); Yu HUANG, Shenzhen (CN)

(73) Assignee: LUXSHARE PRECISION INDUSTRY COMPANY LIMITED, Shenzhen (CN)

(21) Appl. No.: 18/098,329

(22) Filed: Jan. 18, 2023

(30) Foreign Application Priority Data
Jan. 19, 2022 (CN) 202210058480.1

(51) Int. Cl. A24F 40/46; A24D 1/20; A24F 40/20; A24F 40/48; A24D 3/17; A24D 1/02; H05B 3/46

(52) U.S. Cl. CPC A24F 40/46; A24D 1/20; A24F 40/20; A24F 40/48; A24D 3/17; A24D 1/02; H05B 3/46; H05B 2214/04

(57) ABSTRACT

An atomizing core and an atomizer are provided. The atomizing core includes a core, a heater, a flow guiding element, a filter and a tube. The core includes a first end and a second end dispose on an opposite side of the first end. The heater is disposed around an outer periphery of the core. The heater includes a heating pipe and a heat conducting pipe. The heat conducting pipe surrounds and contacts the outer periphery of the core, and the heating pipe surrounds and contacts an outer periphery of the heat conducting pipe. The flow guiding element is disposed on the second end of the core. The filter is disposed on a side of the flow guiding element away from the core. The tube is used to cover the core, the heater, the flow guiding element and filter.

### CROSS REFERENCE TO RELATED APPLICATION

This application claims the priority benefit of Chinese Patent Application Serial Number 202210058480.1, filed on Jan. 19, 2022, the full disclosure of which is incorporated herein by reference.

### BACKGROUND

### Technical Field

The present disclosure relates to the technical field of atomizing device, particularly to an atomizing core and an atomizer.

### Related Art

In the prior art, atomizing devices are applied to atomize specific fillers for use by the user. As an example, the atomizing devices can be an e-cigarette. The e-cigarette is an electronic device that simulates a traditional cigarette and consists of a core, a heating module and a battery. Powered by the battery, the heating module heats the core to produce smoke to simulate smoke of a traditional cigarette.

In current industry, when the core is inserted into the heating module for heating, it is necessary to repeat the insertion several times in order to make the core accurately located in a heating portion of the heating module, so that the core is properly ignited by the heating module. The above repeated inserting action results in complicated ignition steps, which affects use experience of consumers.

On the other hand, the core will only be heated by the heating portion of the heating module at a specific placement angle or position, which makes a portion of the core away from the heating portion to have incomplete burning, resulting in a defect of unilateral irregular burning of the core.

In view of this, how to provide an atomizing core and an atomizer, so that it can heat up rapidly and uniformly for a core, so as the core is burned completely, is an industry urgent problem to be solved.

### SUMMARY

An embodiment of the present disclosure provides an atomizing core and an atomizer, which can solve the problem of incomplete burning in a portion of a current core away from a heating portion, resulting in a defect of unilateral irregular burning of the core.

In order to solve the above technical problems, the present disclosure is realized in this way:

In a first aspect, an atomizing core of an atomizer is provided, which comprises:

a core comprising a first end and a second end, and the second end being disposed on an opposite side of the first end;

a heater, disposed around an outer periphery of the core, wherein the heater comprises a heating pipe and a heat conducting pipe, the heat conducting pipe surrounds and contacts the outer periphery of the core, and the heating pipe surrounds and contacts an outer periphery of the heat conducting pipe;

a flow guiding element, disposed on the second end of the core;

a filter, disposed on a side of the flow guiding element away from the core;

and

a tube covering the core, the heater, the flow guiding element and the filter.

In the atomizing core of the atomizer of the present disclosure, the tube comprises a first electrode and a second electrode, and the first electrode and the second electrode are spaced apart from each other and disposed on an outer periphery of the heating pipe.

In the atomizing core of the atomizer of the present disclosure, the first electrode and the second electrode are annular electrodes and are disposed around the outer periphery of the heating pipe.

In the atomizing core of the atomizer of the present disclosure, the heating pipe is a resistance mesh pipe, the resistance mesh pipe is a mesh-shaped pipe and is disposed between the heat conducting pipe and the tube.

In the atomizing core of the atomizer of the present disclosure, a resistance of the heating pipe is between 0.6 ohms and 1.75 ohms, and a thickness of the heating pipe is 0.02 mm.

In the atomizing core of the atomizer of the present disclosure, the flow guiding element comprises a plurality of flow guiding channels, the plurality of flow guiding channels respectively extend axially from the core to the filter and are spaced apart from each other in a radial direction.

In the atomizing core of the atomizer of the present disclosure, the heater further comprises a heat conducting sheet covering the first end of the core.

In the atomizing core of the atomizer of the present disclosure, the heat conducting pipe is a graphene heat conducting pipe, and the heat conducting sheet is a graphene heat conducting sheet.

In the atomizing core of the atomizer of the present disclosure, a thickness of the graphene heat conducting pipe is 0.05 mm.

In the atomizing core of the atomizer of the present disclosure, the core is composed of at least one of a solid herb, a solid tobacco oil, an herbal filament and a tobacco filament.

In a second aspect, an atomizer is provided, which comprises an atomizer body and the atomizing core as described in the first aspect, wherein the atomizing core is disposed in the atomizer body.

In the atomizer of the present disclosure, the atomizer body comprises a heating module, a main chip control module and a battery module in order from one end to the other end, the heating module is electrically connected to the main chip control module and the battery module, the heating module comprises a heating chamber, and the atomizing core is detachably disposed in the heating chamber of the heating module.

In the atomizer of the present disclosure, the heating module further comprises a first heating electrode and a second heating electrode disposed in the heating chamber, the first heating electrode and the second heating electrode are spaced apart from each other and are correspondingly and electrically connected to the first electrode and the second electrode of the tube of the atomizing core.

In the atomizer of the present disclosure, the first heating electrode comprises a first conducting column and a first conducting sheet, the first conducting sheet comprises a first sleeve portion sleeved on the first conducting column and a first arc-shaped portion connected to the first sleeve portion, and the first arc-shaped portion is disposed on an inner peripheral surface of the heating chamber; the second heating electrode comprises a second conducting column and a second conducting sheet, the second conducting sheet comprises a second sleeve portion sleeved on the second conducting column and a second arc-shaped portion connected to the second sleeve portion, the second arc-shaped portion is disposed on the inner peripheral surface of the heating chamber, and the first arc-shaped portion and the second arc-shaped portion are spaced apart from each other in an axial direction of the heating chamber.

In the embodiment of the present disclosure, by making the tube of the atomizing core comprise the first electrode and the second electrode disposed in a ring shape, when the atomizing core is disposed in the heating chamber of the heating module of the atomizer body, no matter what a radial angle of the atomizing core is, both the first electrode and the second electrode can contact and electrically connect to the first heating electrode and the second heating electrode in the heating chamber, so as to conduct the heater, so that the heater disposed around the outer periphery of the core can be rapidly heated and uniformly heated for the core, thus making the core to be burned completely.

### BRIEF DESCRIPTION OF THE DRAWINGS

The accompanying drawings illustrated herein are used to provide a further understanding of the present disclosure and form part of the present disclosure. The embodiments of the present disclosure and the description thereof are used to explain the present disclosure and do not constitute an undue limitation of the present disclosure. In the drawings:

FIG. 1 is a perspective view of an atomizer of the present disclosure.

FIG. 2 is an exploded view of the atomizer of the present disclosure.

FIG. 3 is an exploded view of an atomizing core of the atomizer of the present disclosure.

FIG. 4 is an enlarged view of an area A in FIG. 3.

FIG. 5 is another schematic view of the atomizing core of the atomizer of the present disclosure.

FIG. 6 is an enlarged view of an area B in FIG. 5.

FIG. 7 is a schematic view of a flow guiding element of the atomizer of the present disclosure.

FIG. 8 is a side view of the atomizer of the present disclosure.

FIG. 9 is a cross-sectional view along a C-C line in FIG. 8.

FIG. 10 is a schematic view of the atomizing core of the atomizer of the present disclosure disposed in a heating module of an atomizer body.

FIG. 11 is an enlarged view of an area D in FIG. 10.

FIG. 12 is a schematic view of a first heating electrode and a second heating electrode of the atomizer of the present disclosure.

### DETAILED DESCRIPTION OF THE EMBODIMENTS

The technical solution in the embodiments of the present disclosure will be clearly and completely described below with reference to the accompanying drawings in the embodiments of the present disclosure. It is to be understood that the described embodiments are merely exemplary of the disclosure, and not restrictive of the full scope of the invention. All other embodiments, which can be obtained by a person skilled in the art without inventive step based on the embodiments of the present disclosure, are within the scope of the present disclosure.

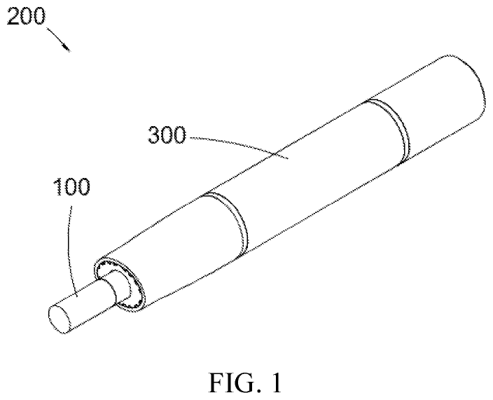

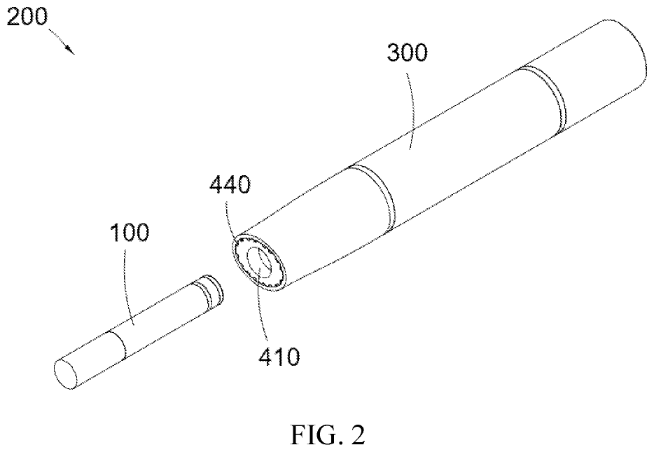

As shown in FIG. 1 and FIG. 2, the present disclosure relates to an atomizing core 100 and an atomizer 200, and the atomizing core 100 is inserted into the atomizer 200 for heating to produce smoke for use by a consumer.

The following will first describe the atomizing core 100 of the present disclosure.

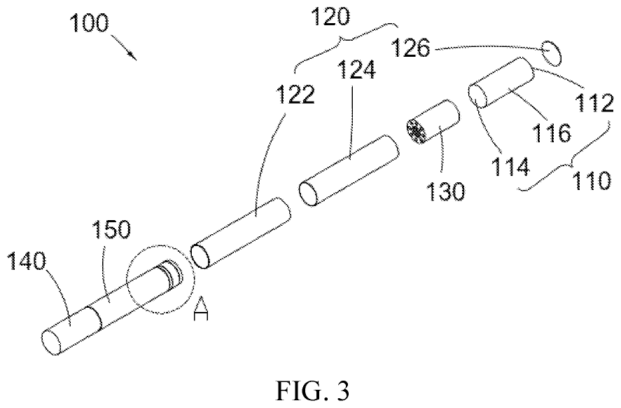

As shown in FIG. 3, the atomizing core 100 comprises a core 110, a heater 120, a flow guiding element 130, a filter 140 and a tube 150. The core 110 comprises a first end 112 and a second end 114, and the second end 114 is disposed on an opposite side of the first end 112. The heater 120 is disposed around an outer periphery 116 of the core 110. The heater 120 comprises a heating pipe 122 and a heat conducting pipe 124. The heat conducting pipe 124 surrounds and contacts the outer periphery 116 of the core 110, and the heating pipe 122 surrounds and contacts an outer periphery of the heat conducting pipe 124, thereby completing the heating of the core 110. The flow guiding element 130 is disposed on the second end 114 of the core 110, and the filter 140 is disposed on a side of the flow guiding element 130 away from the core 110, so that the flow guiding element 130 can guide the generated smoke to the filter 140. The tube 150 is used to cover the core 110, the heater 120, the flow guiding element 130 and the filter 140. In an embodiment of FIG. 3, the filter 140 and the tube 150 have been integrally formed in an assembly stage, but this is not a limitation.

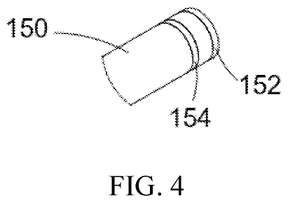

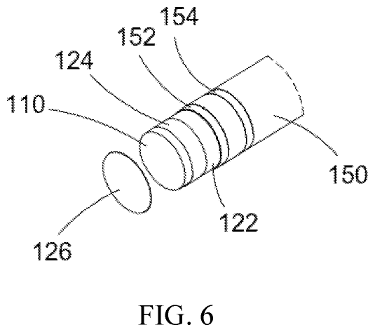

As shown in an enlarged view of FIG. 4, the tube 150 has a first electrode 152 and a second electrode 154, and the first electrode 152 and the second electrode 154 are spaced apart from each other and disposed on an outer periphery of the heating pipe 122 (as shown in FIG. 6). That is, the first electrode 152 and the second electrode 154 of the tube 150 are disposed corresponding to the outer periphery of the heating pipe 122. Preferably, the first electrode 152 and the second electrode 154 are annular electrodes and are disposed around the outer periphery of the heating pipe 122.

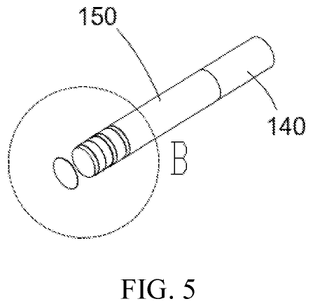

In an embodiment, the assembly sequence of the atomizing core 100 of the present disclosure is as follows: (1) assembling the core 110 and the flow guiding element 130 shown in FIG. 3; (2) disposing the heat conducting pipe 124 of the heater 120 on the assembled core 110 and the flow guiding element 130, and then disposing the heating pipe 122 of the heater 120 on the outer periphery of the heating pipe 124, and (3) disposing the tube 150 with the filter 140 on the heating pipe 122. Please refer to FIG. 5 and FIG. 6 for a sleeve relationship of the components of the atomizing core 100 after the assembly is completed.

The above assembling sequence can also be changed according to other requirements, which is not limited here. For example, the heat conducting pipe 124 and the heating pipe 122 of the heater 120 can be sequentially assembled in the tube 150 with the filter 140, and then the flow guiding element 130 and the core 110 can be accommodated in the heater 120 in sequence.

Please refer to FIG. 3 again, in an embodiment, the heating pipe 122 is a resistance mesh pipe, and the resistance mesh pipe is a mesh-shaped pipe and is disposed between the core 110 and the tube 150.

As shown in FIG. 3 and FIG. 6, the heater 120 further comprises a heat conducting sheet 126. The heat conducting pipe 124 is disposed on the outer periphery 116 of the core 110, and the heat conducting sheet 126 covers the first end 112 of the core 110. In other words, the heat conducting pipe 124 is disposed between the core 110 and the heating pipe 122.

By making the heat conducting pipe 124 surrounds and contacts the outer periphery 116 of the core 110, the heating pipe 122 surrounds and contacts the outer periphery of the heat conducting pipe 124, and the heat conducting sheet 126 covers the first end 112 of the core 110, after the first electrode 152 and the second electrode 154 of the tube 150 are electrically connected through the heating pipe 122, the heating pipe 122 can be rapidly heated to about 300° C. to 320° C. in a short time to complete the heating, and the heat generated by the heating pipe 122 can be further conducted through the heat conducting pipe 124 and the heat conducting sheet 126 to bake the outer periphery 116 and the first end 112 of the core 110, so that the core 110 generates smoke due to the burning. Finally, the smoke enters the user's mouth or nasal cavity along the flow guiding element 130 and the filter 140 by the user's suction.

In an embodiment, a resistance of the heating pipe 122 is between 0.6 ohms and 1.75 ohms, and a thickness of the heating pipe 122 is 0.02 mm. The heat conducting pipe 124 is a graphene heat conducting pipe, the heat conducting sheet 126 is a graphene heat conducting sheet, and both thicknesses of them are 0.05 mm, so as to provide excellent heat transfer efficiency with thinning. In addition, a high melting point of graphene can also avoid the problem of dry burning, thereby greatly improving the safety of burning. The core 110 is composed of at least one of solid herb, a solid tobacco oil, an herbal filament and a tobacco filament, so that it can be adjusted according to the needs of different users.

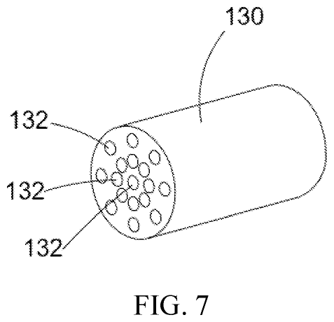

As shown in FIG. 7, the flow guiding element 130 comprises a plurality of flow guiding channels 132, the plurality of flow guiding channels 132 respectively extend axially from the core 110 to the filter 140 and are spaced apart from each other in a radial direction. In a preferred embodiment, a radial arrangement of the plurality of flow guiding channels 132 is as follows: a single flow guiding channel 132 is disposed in a middle, a plurality of flow guiding channels 132 arranged in a ring are disposed on a second layer outside the single flow guiding channel 132, and a plurality of flow guiding channels 132 are arranged in a circular disposed on a third layer outside the single flow guiding channel 132. In some embodiments, an arrangement density of the flow guiding channels 132 on the second layer and the flow guiding channels 132 on the third layer are different (i.e., intervals between two adjacent flow guiding channels 132 in a circumferential direction are different). Through an arrangement of the plurality of flow guiding channels 132, the flow guiding element 130 can guide atomized gas more uniformly and can improve the heat dissipation effect to help reduce the temperature of the smoke generated by the core 110 due to the burning. In some embodiments, a material with high thermal conductivity, such as copper, may be used to help dissipate heat.

An atomizer 200 of the present disclosure comprises an atomizer body 300 and the above atomizing core 100, and the atomizing core 100 is disposed in the atomizer body 300.

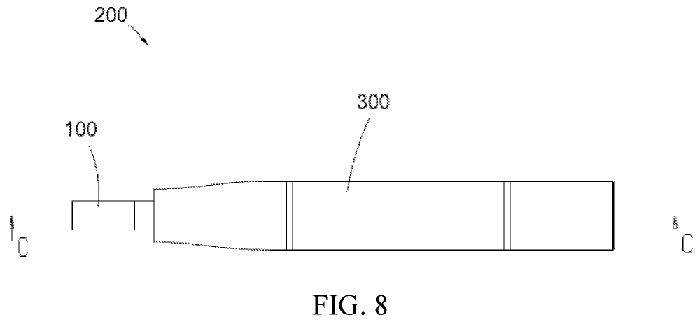

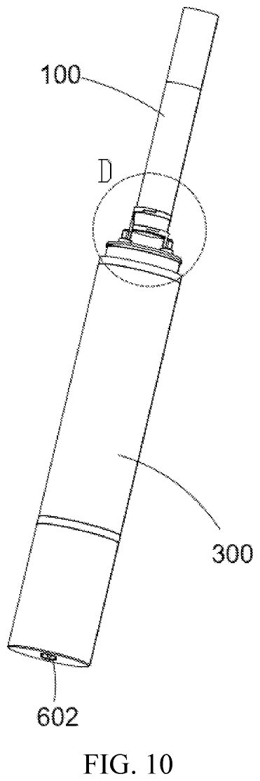

As shown in FIG. 8 and FIG. 10, the atomizer body 300 comprises a heating module 400, a main chip control module 500 and a battery module 600 in order from one end (the left end of the drawing) to the other end (the right end of the drawing). The heating module 400 is electrically connected to the main chip control module 500 and the battery module 600, the heating module 400 comprises a heating chamber 410, and the atomizing core 100 is detachably disposed in the heating chamber 410 of the heating module 400.

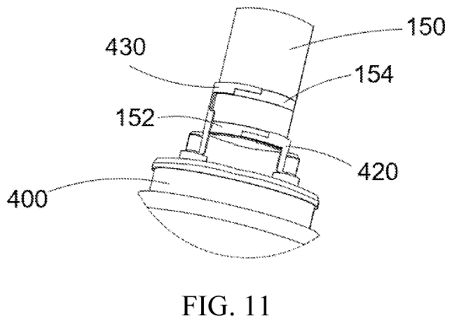

Further, as shown in FIG. 10 and FIG. 11, the heating module 400 further comprises a first heating electrode 420 and a second heating electrode 430 disposed in the heating chamber 410. The first heating electrode 420 and the second heating electrode 430 are disposed opposite and spaced apart from each other at a bottom of the heating chamber 410, and the first heating electrode 420 and the second heating electrode 430 are correspondingly and electrically connected to the first electrode 152 and the second electrode 154 of the tube 150 of the atomizing core 100. The main chip control module 500 can only allow the battery module 600 to perform related power supply operations when it detects that the first heating electrode 420 and the second heating electrode 430 are in an on state or when a specific resistance value is measured to ensure the safety of the atomizer body 300 during use.

In the present disclosure, since the first electrode 152 and the second electrode 154 of the tube 150 are both annular electrodes, when the atomizing core 100 is inserted into the heating chamber 410 of the heating module 400, no matter a radial angle of the atomizing core 100 is, both the first electrode 152 and the second electrode 154 can contact and electrically connect to the first heating electrode 420 and the second heating electrode 430 in the heating chamber 410, so that the heating pipe 122 can complete the conduction between the first electrode 152 and the second electrode 154 and heat up the heating pipe 122.

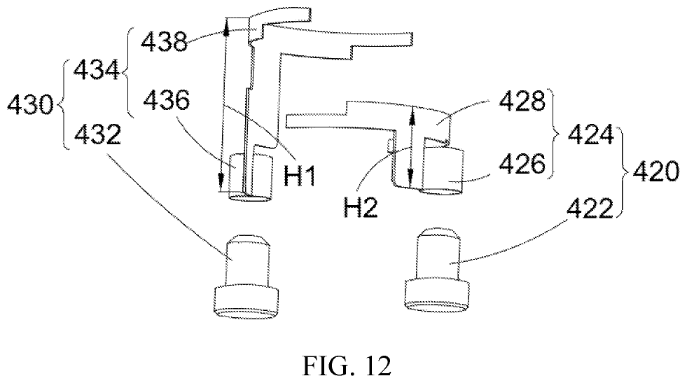

It should be noted that, as shown in FIG. 11 and FIG. 12, in the present disclosure, the first heating electrode 420 comprises a first conducting column 422 and a first conducting sheet 424. The first conducting sheet 424 comprises a first sleeve portion 426 sleeved on the first conducting column 422 and a first arc-shaped portion 428 connected to the first sleeve portion 426, and the first arc-shaped portion 428 is disposed on an inner peripheral surface of the heating chamber 410. The second heating electrode 430 comprises a second conducting column 432 and a second conducting sheet 434. The second conducting sheet 434 comprises a second sleeve portion 436 sleeved on the second conducting column 432 and a second arc-shaped portion 438 connected to the second sleeve portion 436, the second arc-shaped portion 429 is disposed on the inner peripheral surface of the heating chamber 410, and the first arc-shaped portion 428 and the second arc-shaped portion 438 are spaced apart from each other in an axial direction of the heating chamber 410.

In a preferred embodiment, the first conducting sheet 424 is an L-shape electrode that extends upward along the axial direction of the heating chamber 410 by a first height H1, and then extends along an inner surface of the heating chamber 410 after bending 90 degrees. Similarly, the second conducting sheet 434 is an L-shaped electrode that extends upward along the axial direction of the heating chamber 410 by a second height H2, and then extends along the inner surface of the heating chamber 410 after bending 90 degrees. Because the first heating electrode 420 contacts and electrically connects to the first electrode 152, and the second heating electrode 430 contacts and electrically connects to the second electrode 154, the above first height H1 and the second height H2 are different from each other, and a height difference between the first height H1 and the second height H2 can be regarded as a distance between the first electrode 152 and the second electrode 154.

In another embodiment, after the first conducting sheet 424 extends upward along the axial direction of the heating chamber 410 by the first height H1, it can also be bent by 90 degrees to the left and right and extended along the inner surface of the heating chamber 410, thereby forming a T-shaped electrode. Similarly, after the second conducting sheet 434 extends upward along the axial direction of the heating chamber 410 by the second height H2, it can also be bent by 90 degrees to the left and right and extended along the inner surface of the heating chamber 410, thereby forming another T-shaped electrode.

In the present disclosure, whether the first conducting sheet 424 and the second conducting sheet 434 are L-shaped or T-shaped, they are able to ensure a good electrical connection with the first electrode 152 and the second electrode 154 of the tube 150 because of a large contact area. In addition, ends of the first conducting sheet 424 and the second conducting sheet 434 can be designed to be concave-convex according to the needs of use, and can also have other shapes such as sawtooth or chamfer.

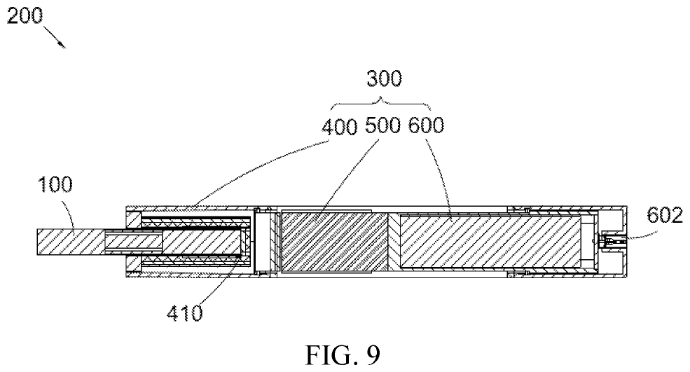

As shown in FIG. 9, in the present disclosure, in addition to controlling charging efficiency of the battery module 600, the main chip control module 500 can also have functions such as health monitoring reminder, fingerprint identification for minors, Bluetooth transmission, iPASS Card, and emergency help. The battery module 600 has a charging interface 602, and the charging interface 602 is a USB interface, preferably a Type C interface and has an OTG function, so as to facilitate obtaining power from other portable devices.

An appearance of the atomizer body 300 of the present disclosure may be square, circular, rectangular, oval, or racetrack shape, which is not limited herein. In addition, as shown in FIG. 2, oxygen is circulated into the heating chamber 410 from a plurality of air inlet holes 440 at a periphery of the heating chamber 410, so that the core 110 can interact with it and be burned.

In summary, the present disclosure is to make the tube 150 of the atomizing core 100 comprise the first electrode 152 and the second electrode 154 disposed in a ring shape, when the atomizing core 100 is disposed in the heating chamber 410 of the heating module 400 of the atomizer body 300, no matter the radial angle of the atomizing core 100 is, both the first electrode 152 and the second electrode 154 on the tube 150 of the atomizing core 100 can be quickly connected to the first heating electrode 420 and the second heating electrode 430 in the heating chamber 410, so as to conduct the heating pipe 122. In addition, the heating pipe 122 can be rapidly heated to about 300° C. to 320° C. in a short time after the conduction to complete the heating, and conduct the heat to the heat conducting pipe 124 and the heat conducting sheet 126, so that the heat conducting pipe 124 disposed around the outer periphery of the core 110 and the heat conducting sheet 126 covered the first end 112 of the core 110 can be heated uniformly against the core 110, and thus the core 110 is burned completely, and the defect of unilateral irregular burning of the core 110 is avoided.

It is to be understood that the term “comprises”, “comprising”, or any other variants thereof, is intended to encompass a non-exclusive inclusion, such that a process, method, article, or device of a series of elements not only include those elements but also comprises other elements that are not explicitly listed, or elements that are inherent to such a process, method, article, or device. An element defined by the phrase “comprising a . . . ” does not exclude the presence of the same element in the process, method, article, or device that comprises the element.

Although the present disclosure has been explained in relation to its preferred embodiment, it does not intend to limit the present disclosure. It will be apparent to those skilled in the art having regard to this present disclosure that other modifications of the exemplary embodiments beyond those embodiments specifically described here may be made without departing from the spirit of the disclosure. Accordingly, such modifications are considered within the scope of the disclosure as limited solely by the appended claims.

What is claimed is:

1. An atomizing core of an atomizer, comprising:
a core comprising a first end and a second end, and the second end being disposed on an opposite side of the first end;
a heater, disposed around an outer periphery of the core, wherein the heater comprises a heating pipe and a heat conducting pipe, the heat conducting pipe surrounds and contacts the outer periphery of the core, and the heating pipe surrounds and contacts an outer periphery of the heat conducting pipe;
a flow guiding element, disposed on the second end of the core;
a filter, disposed on a side of the flow guiding element away from the core; and
a tube covering the core, the heater, the flow guiding element and the filter.

2. The atomizing core of the atomizer according to claim 1, wherein the tube comprises a first electrode and a second electrode, and the first electrode and the second electrode are spaced apart from each other and disposed on an outer periphery of the heating pipe.

3. The atomizing core of the atomizer according to claim 2, wherein the first electrode and the second electrode are annular electrodes and are disposed around the outer periphery of the heating pipe.

4. The atomizing core of the atomizer according to claim 1, wherein the heating pipe is a resistance mesh pipe, the resistance mesh pipe is a mesh-shaped pipe and is disposed between the heat conducting pipe and the tube.

5. The atomizing core of the atomizer according to claim 4, wherein a resistance of the heating pipe is between 0.6 ohms and 1.75 ohms, and a thickness of the heating pipe is 0.02 mm.

6. The atomizing core of the atomizer according to claim 1, wherein the flow guiding element comprises a plurality of flow guiding channels, the plurality of flow guiding channels respectively extend axially from the core to the filter and are spaced apart from each other in a radial direction.

7. The atomizing core of the atomizer according to claim 1, wherein the heater further comprises a heat conducting sheet covering the first end of the core.

8. The atomizing core of the atomizer according to claim 7, wherein the heat conducting pipe is a graphene heat conducting pipe, and the heat conducting sheet is a graphene heat conducting sheet.

9. The atomizing core of the atomizer according to claim 8, wherein a thickness of the graphene heat conducting pipe is 0.05 mm.

10. The atomizing core of the atomizer according to claim 1, wherein the core is composed of at least one of a solid herb, a solid tobacco oil, an herbal filament and a tobacco filament.

11. An atomizer, comprising:
an atomizer body; and
the atomizing core of claim 1, disposed in the atomizer body.

12. The atomizer according to claim 11, wherein the atomizer body comprises a heating module, a main chip control module and a battery module in order from one end to the other end, the heating module is electrically connected to the main chip control module and the battery module, the heating module comprises a heating chamber, and the atomizing core is detachably disposed in the heating chamber of the heating module.

13. The atomizer according to claim 11, wherein the tube comprises a first electrode and a second electrode, and the first electrode and the second electrode are spaced apart from each other and disposed on an outer periphery of the heating pipe.

14. The atomizer according to claim 13, wherein the heating module further comprises a first heating electrode and a second heating electrode disposed in the heating chamber, the first heating electrode and the second heating electrode are spaced apart from each other and are correspondingly and electrically connected to the first electrode and the second electrode of the tube of the atomizing core.

15. The atomizer according to claim 14, wherein the first electrode and the second electrode are annular electrodes and are disposed around the outer periphery of the heating pipe.

16. The atomizer according to claim 14, wherein the first heating electrode comprises a first conducting column and a first conducting sheet, the first conducting sheet comprises a first sleeve portion sleeved on the first conducting column and a first arc-shaped portion connected to the first sleeve portion, and the first arc-shaped portion is disposed on an inner peripheral surface of the heating chamber; the second heating electrode comprises a second conducting column and a second conducting sheet, the second conducting sheet comprises a second sleeve portion sleeved on the second conducting column and a second arc-shaped portion connected to the second sleeve portion, the second arc-shaped portion is disposed on the inner peripheral surface of the heating chamber, and the first arc-shaped portion and the second arc-shaped portion are spaced apart from each other in an axial direction of the heating chamber.

17. An atomizer, comprising:
an atomizer body; and
an atomizing core, disposed in the atomizer body,
wherein the atomizer body comprises:
a heating module, comprising a heating chamber;
a first heating electrode, comprising:
a first conducting column; and
a first conducting sheet, comprising a first sleeve portion sleeved on the first conducting column and a first arc-shaped portion connected to the first sleeve portion, and the first arc-shaped portion being disposed on an inner peripheral surface of the heating chamber; and
a second heating electrode, comprising:
a second conducting column; and
a second conducting sheet, comprising a second sleeve portion sleeved on the second conducting column and a second arc-shaped portion connected to the second sleeve portion, the second arc-shaped portion being disposed on the inner peripheral surface of the heating chamber,
wherein the first arc-shaped portion and the second arc-shaped portion are spaced apart from each other in an axial direction of the heating chamber.

18. The atomizer according to claim 17, wherein the atomizing core comprises:
a core comprising a first end and a second end, and the second end being disposed on an opposite side of the first end;
a heater, disposed around an outer periphery of the core, wherein the heater comprises a heating pipe and a heat conducting pipe, the heat conducting pipe surrounds and contacts the outer periphery of the core, and the heating pipe surrounds and contacts an outer periphery of the heat conducting pipe;
a flow guiding element, disposed on the second end of the core;
a filter, disposed on a side of the flow guiding element away from the core; and
a tube covering the core, the heater, the flow guiding element and the filter.

19. The atomizer according to claim 18, wherein the tube comprises a first electrode and a second electrode, and the first electrode and the second electrode are spaced apart from each other and disposed on an outer periphery of the heating pipe; wherein the first arc-shaped portion and the second arc-shaped portion are correspondingly and electrically connected to the first electrode and the second electrode.
